(19) United States
(12) Patent Application Publication
(10) Pub. No.: US 2011/0184852 A1
(43) Pub. Date: Jul. 28, 2011

(54) SECURED ACQUISITION PROCESS VIA CREDIT CARD TERMINAL

(76) Inventor: Rafi Refaeli, Kiryat Ata (IL)

(21) Appl. No.: 12/674,587

(22) PCT Filed: Aug. 24, 2008
(86) PCT No.: PCT/IL2008/001156

§ 371 Date: Apr. 6, 2011

Related U.S. Application Data
(60) Provisional application No. 60/965,575, filed on Aug. 22, 2007.
(60) Provisional application No. 61/037,511, filed on Mar. 18, 2008.

(51) Int. Cl. G06Q 20/00

(52) U.S. Cl. 705/39

(57) ABSTRACT

The present invention provides a system and method for managing acquisition of goods using a credit card of a client in a way whereby the details of the credit card are not exposed or revealed to the supplier or the seller throughout the acquisition process. This method can bring about new users that are not buying merchandise through the internet due to their fear from credit card frauds. This method can also bring about new users that are not buying merchandise using a credit card in which the details of the credit card are exposed directly or indirectly to a supplier due to their fear from future misuse of their credit card details.

### FIELD OF THE INVENTION

The present invention relates to secured use of credit cards. More particularly, the present invention relates to a method allowing secure credit card transactions, using a credit card terminal, in a way whereby the details of the credit card are not exposed or revealed to the supplier or the seller throughout the acquisition process.

### BACKGROUND OF THE INVENTION

People would like to safely use their credit cards anywhere and from everywhere; however, the fear from exposing the details of the credit card directly or indirectly through a phone, IVR (Interactive Voice Response) or the Internet prevents them from doing so.

Current use of credit cards, that is not direct at a selling location, involves a user selecting a product via Internet or from catalogues, as examples, then the user (buyer) provides the details of his credit card by phone or by filling a form over the Internet, as examples; the selling side checks the credentials and the balance of the credit card with the credit card clearing company, once the credit card is approved for the sell, the seller provides the product and charges the credit card. This process is schematically depicted in FIGS. 1 and 2.

In the above process some parts my use encryption or other secure means for relaying the information or for protecting information that is kept in different locations. Yet, there are well known misuses and theft of credit cards information either by or at seller locations or from distributors' servers.

In prior art (U.S. Pat. No. 5,754,655, System for remote purchase payment and remote bill payment transactions, Hughes; Thomas S. and Molina; Gustavo) a terminal is provided for allowing a user to conduct remote purchase payment and remote bill payment transactions with a remote host computer. A memory is coupled to the controller for storing a transaction log of purchase payment transactions, each purchase payment transaction in the transaction log comprising a date and a time of purchase payment transaction, an amount of the purchase payment transaction, information identifying a merchant, information identifying an item or service purchased, and data for identifying the transaction.

### SUMMARY OF THE INVENTION

It is an object of the present invention to provide a system and method for managing acquisition of goods using a credit card of a client in a way whereby the details of the credit card are not exposed or revealed to the supplier or the seller throughout the acquisition process.

It is another object of the present invention to provide a trusted server for managing the acquisition process.

It is thus provided in accordance with a preferred embodiment of the present invention a system for performing acquisition process by a user from a supplier, during which client acquisition data CAD is transmitted to supplier and sensitive data is raveled only to a trusted party, comprising:
a trusted system capable of validating the sensitive data pertaining to the user and payment details,
wherein the user acquires a product from the supplier and payment information is solely and directly transmitted to said trusted system.

Furthermore, in accordance with another preferred embodiment of the present invention, the supplier offers the product through an advertisement channel such as website, commerce site on the Internet, television through which acquisition can be performed.

Furthermore, in accordance with another preferred embodiment of the present invention, the products are goods or services.

Furthermore, in accordance with another preferred embodiment of the present invention, the system further comprises a credit card terminal CCT through which the sensitive data is transmitted.

Furthermore, in accordance with another preferred embodiment of the present invention, the CCT is a terminal such as a device integrated in a computer keyboard, re-configured or re-programmed credit card terminal, a cellular phone.

Furthermore, in accordance with another preferred embodiment of the present invention, the CAD includes details such as selected products, quantity and terms of acquisition, name and address to which the products are shipped, payment terms, and an identification of communication means to said CCT.

Furthermore, in accordance with another preferred embodiment of the present invention, the CCT is capable of receiving the sensitive data and is capable of encrypting the sensitive data and transmitting it to said trusted system.

Furthermore, in accordance with another preferred embodiment of the present invention, the trusted system comprises an acquisition transfer server ATS and a secured payment server SPS, wherein ATS is capable of receiving sensitive information from the user and acquisition information from the supplier; wherein the ATS is capable of transmitting information to SPS for validation.

Furthermore, in accordance with another preferred embodiment of the present invention, the sensitive information is credit card details and the system further comprises a clearing credit card system.

Furthermore, in accordance with another preferred embodiment of the present invention, a method of handling acquisition process without revealing sensitive details of a user to a supplier comprising revealing the sensitive information to a trusted system wherein the supplier of products is not exposed to the sensitive information.

It is thus provided in accordance with a preferred embodiment of the present invention a method of handling acquisition process from a supplier by a user equipped with a CCT comprising:
transmitting client acquisition data CAD to the supplier;
revealing sensitive information only to a trusted system;
verifying and validating the sensitive data and payment details pertaining to the user;
wherein the user acquires a product from the supplier via the CAD and payment information is solely and directly transmitted with the CCT to the trusted system that is responsible for validating the payment details.

Furthermore, in accordance with another preferred embodiment of the present invention, verifying and validating the sensitive data and payment details pertaining to the user is done by said SPS.

Furthermore, in accordance with another preferred embodiment of the present invention, the sensitive information includes user's credit card information.

Furthermore, in accordance with another preferred embodiment of the present invention, wherein for verifying and validating the sensitive data and payment details pertaining to the user, the SPS transfers the data to a clearing credit card system.

Furthermore, in accordance with another preferred embodiment of the present invention, further comprising finalizing the acquisition process and notifying the user and the supplier by said trusted system upon successful validation of the sensitive data.

Furthermore, in accordance with another preferred embodiment of the present invention, further comprising finalizing the acquisition process and notifying the user and the supplier by said trusted system upon successful validation of the sensitive data, wherein notifying includes commercial data.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

For clarity, non-essential elements were omitted from some of the drawings.

In the drawings:

FIG. 1 illustrates a method known in prior art for conducting goods acquisition with a credit card.

FIG. 2 illustrates a system and protocol known in prior art for implementing goods acquisition with a credit card.

FIG. 3 illustrates a system through which a secured acquisition can be performed in accordance with a preferred embodiment of the present invention.

FIG. 4 illustrates a detailed embodiment of the acquisition process, as an example, of a system through which a secured acquisition can be performed in accordance with a preferred embodiment of the present invention.

### DESCRIPTION OF PREFERRED EMBODIMENTS

The present invention provides a method and system for managing acquisitions of goods using a credit card of a client in a way whereby the details of the credit card are not exposed or revealed to the supplier or the seller throughout the acquisition process. This method can bring about new users that are not buying merchandise through the internet due to their fear from credit card frauds. This method can also bring about new users that are not buying merchandise using a credit card in which the details of the credit card are exposed directly or indirectly to a supplier due to their fear from future misuse of their credit card details.

The present invention provides a new method of buying goods through a client Credit Card Terminal (CCT) such as a cellular phone through which the credit card details are being transferred in a secured way directly to a credit card clearing server comprising an Acquisition Transfer Server (ATS) and a Secured Payment Server (SPS), without revealing any details of the client's credit card, to the selling party. Only the credit card company and its clearing company that use the method presented in this invention are informed of the details. The validation of the credit card and the credit line is being performed by the ATS and SPS. Optionally, when the ATS and SPS are part of a trusted system that is not the clearing credit card company, the data is sent from the SPS for validation in the clearing credit card company. Once the transaction is validated, the acquisition of the product is approved and the credit card can be charged.

Initializing a buying process by a client initiates an acquiring transaction through a client credit card terminal (CCT) specifically built, for example a device integrated in a computer keyboard, or re-configured, for example a re-programmed credit card terminal or with a device adapted for the referenced use, for example a cellular phone adapted for the required purposes optionally with an encryption chip.

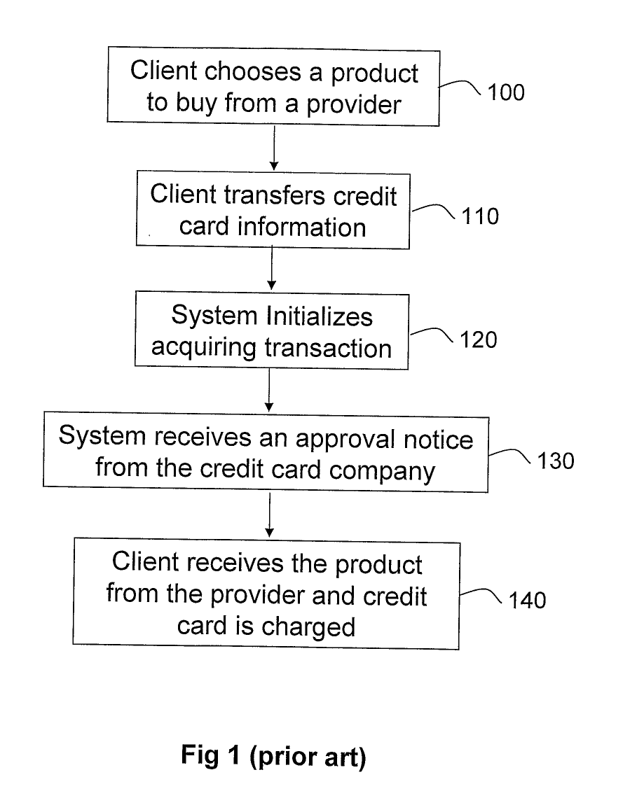

Reference is now made to FIG. 1 illustrating a method known in prior art for conducting goods acquisition with a credit card. A client chooses a product to buy from a provider, 100; next, the client transfers credit card information and other details to the supplier, 110; next, the system in the supplier site Initializes acquiring transaction, 120; next, the system request s and receives an approval notice from the credit card company, 130; next, the transaction is finalized and the client receives the product from the provider and credit card is charged. Note that in this method the details of the user's credit card are revealed to the supplier.

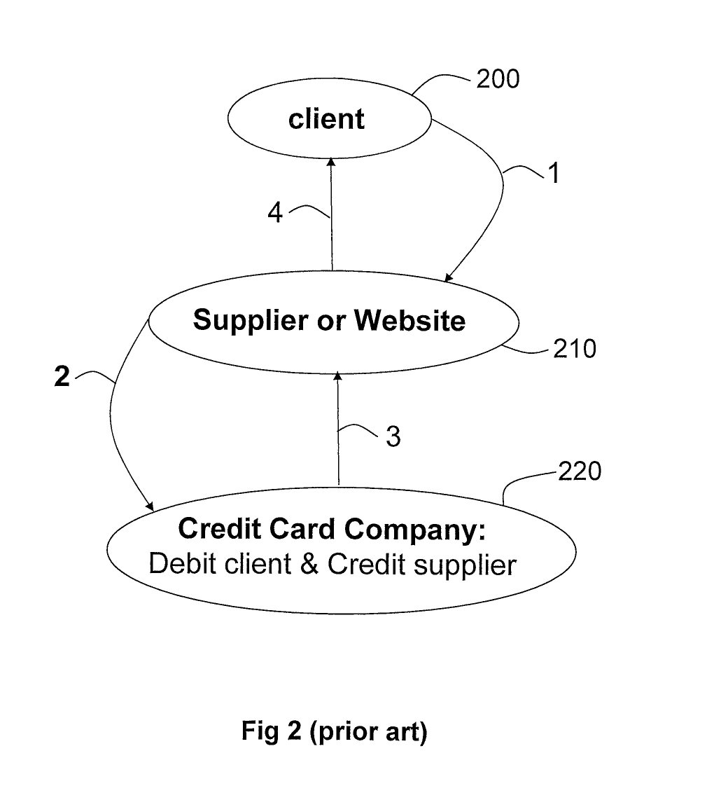

Reference is now made to FIG. 2 illustrating a system and protocol known in prior art for implementing goods acquisition with a credit card. In this system there are three entities: a client 200, a supplier 210 and a clearing credit card company 220. The arrows in the figure represent direction of data transmission between the entities and the numbers on the arrows represent messages IDs. In 1, the request for goods and the credit card information is sent to the supplier; in 2, the supplier asks from the clearing credit card company to verify the client and his credit line; in 3 and 4, responses are provided to the supplier and the client.

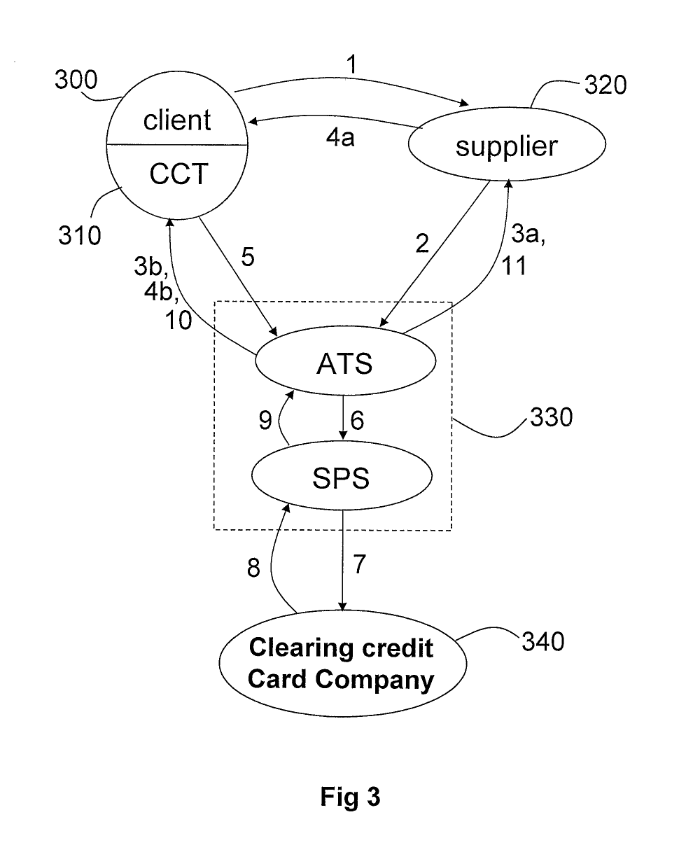

Reference is now made to FIG. 3 illustrating a system and method through which a secured acquisition can be performed in accordance with a preferred embodiment of the present invention. The system through which the secured acquisition is performed involves four entities: a client 300 that performs the purchase and preferably has a CCT 310, a supplier 320 having preferably a website through which acquisition can be performed, a reliable and secured trusted system 330 for interacting with the client, the supplier, and the clearing credit card company 340. The arrows in the figure represent direction of data transmission between the entities and the numbers on the arrows represent messages IDs.

In accordance with a preferred method of the present invention, the client is browsing a commerce site on the Internet or on a television or in a catalogue to purchase a good or a service. In 1, a message is transmitted over a link or virtual link (such as a telephone call); the client then provides the supplier with Client Acquisition Data (CAD). The CAD includes the selected products or services, quantity and terms of acquisition, name and address to which the goods are going to be shipped, and payment terms; optionally, any other relevant data can be provided. Credit card details are not provided at that point.

Then, similar to most commerce sites, the supplier generates a transaction containing the acquired information and sends to the client summary of the acquisition information. In addition, in according with the present invention, the client is requested to supply in the CAD an identification of a secured means or device such as CCT to be used securely by the client and a clearing card service for transferring credit card information.

Next, the supplier transmits a message 2, with a Unique Supplier ID (USI) and the client acquisition data (CAD), to an Acquisition Transfer Server (ATS) of the relevant clearing credit card service. Optionally, this is done through a website billing software, or by using an electronic web-service new extension as a preferred method of the present invention. The CAD is validated in the ATS and in case that the acquired transaction is approved by the supplier and the data passes the validation in a good condition, the CAD is stored in the ATS database and a Unique Acquisition ID (UAI) is created. In case the checks (validation) fail, the website or the software provides an alert message containing an error code and error handling means by which correction of the CAD can be performed.

Next, the ATS transmits a message 3, with the UAI, which was created in the ATS, back to the supplier's website or software. The UAI is also transmitted to the client so as to be used in the CCT. In an optional scenario, the client also provides, within the CAD, the details for communicating with the CCT, such as phone access number. In such option, the ATS will transmit the UAI, in message 4b, directly to the CCT. Optionally, the UAI is transmitted from the supplier to the client in message 4a. The client uses the CCT and adds the relevant details of his credit card. The software in the CCT uses this information and generates Credit Card Data (CCD). Optionally, the CCD can be encrypted.

Next, the CCT transmits the CCD and the UAI to the ATS, in message 5. The ATS uses the UAI data from message 5 and matches it with the generated UAI. The corresponding unique supplier id (USI), and the client acquisition data (CAD) supplied by the supplier, in message 2 are joined with the credit card data (CCD) supplied by the client for the given UAI.

Next, the ATS transmits to the Secured Payment Server (SPS), message 6 with the USI, CAD and CCD. Optionally, ATS can transmit in parallel, a processing notification message to the client through the CCT.

Next, the SPS transmits to the clearing credit card company message 7 with the USI, CAD and CCD and requests to validate the transaction. Optionally, the SPS is a server of the clearing credit card company. The credentials of the client and its credit line are checked at the clearing credit card company.

Next, the clearing credit card company site generates a return message 8 and sends it back to the SPS. The message can be a failure or a success notification. From the SPS, the message is sent to the ATS in message 9. The results are interpreted in the ATS and sent to the client CCT in message 10 and the supplier in message 11.

Upon a failure message the CCT is provided in message 10 with an alert message containing an error code and error handling means by which correction of the CCD can be performed, and the supplier is notified of a failure in message 11.

In case that the transaction is approved, the Transaction Success ID (TSI) is stored in the ATS database together with the corresponding UAI, and the acquisition is finalized. The TSI as well as a success message are being sent both to the supplier's website (message 11) and to the CCT (message 10).

Optionally, the client waits for the results to be displayed via the CCT or the supplier's website. It should be noted that preferably, during the waiting time of the client, a commercial or any client specific data can be displayed on the CCT unit or via the supplier's website.

Optionally, together with the TSI and the success message a commercial is being sent both to the supplier's website and to the CCT. It is also optional to send to the client specific data to its CCT. Both acquisition information and the transaction confirmation is stored as proof of purchase on the CCT.

In the supplier's domain, the TSI is stored in a local billing system as proof of purchase and both acquisition information and the transaction confirmation can be displayed to the client through the supplier's website. The goods that were purchased by the client are being sent to him according to the details that were entered in the supplier's purchase form at the beginning of the process as a part of the CAD.

It should be noted that the operators of the secured service (trusted system) described herein before collect fees for each transaction that is performed through the secured system. The collection of fees can be performed by collection of a constant fee or a percentage of the money transaction. The collection of money can be made from the client, the supplier, the credit card companies, credit insurance companies, cellular companies or any other combination therein.

It should be noted that there are several waiting zones in the CCT as well as the supplier website in which commercials or advertisement banners can be displayed as well as any client specific data that can be presented to him such as monthly credit reports or other information requested by the client. In accordance with a preferred embodiment of the present invention, a method of integrating such service is presented in which fees are being collected from commercial campaigns for displaying their campaign. In accordance with another preferred embodiment of the present invention, fees are being collected from the client for displaying requested information that can be supplied to him and is requested throughout the process of purchasing goods through the secured credit card transaction.

It is yet another embodiment of the present invention to offer clients and suppliers with a website were they can each receive reports of previous transactions, make inquires, request a refund, and receive other services etc.

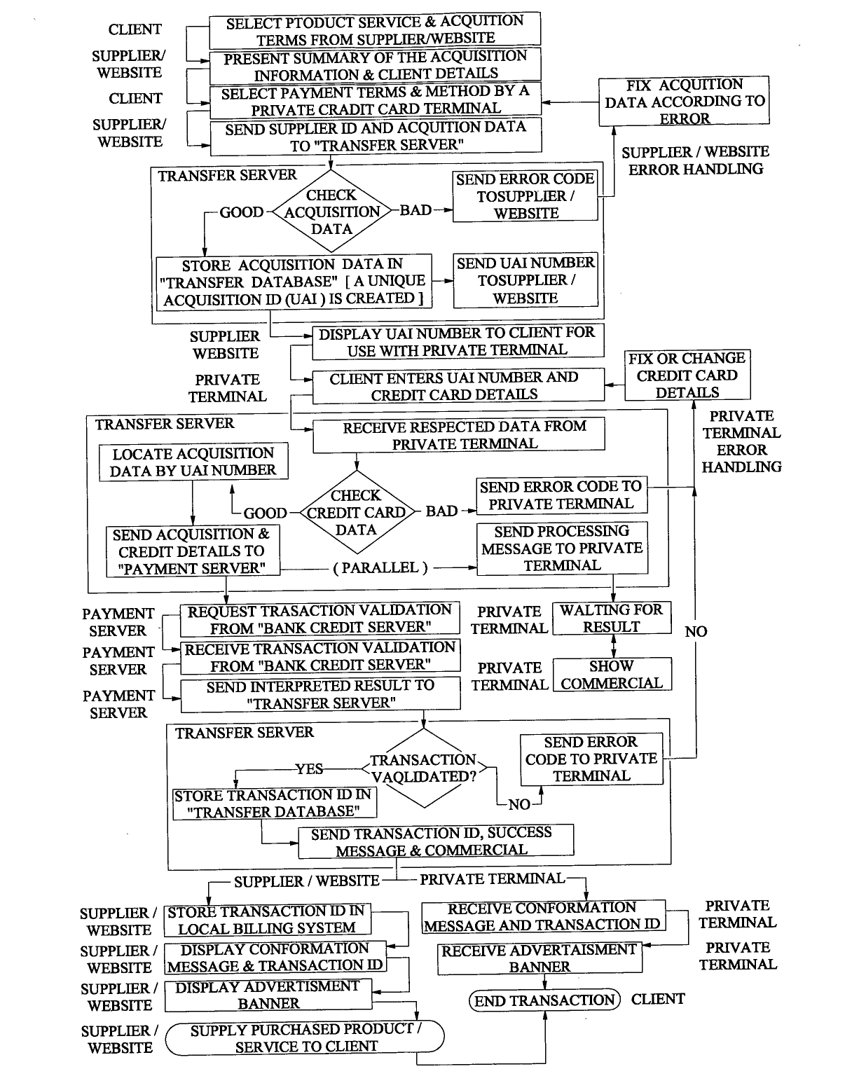

FIG. 4 illustrates a detailed embodiment of the acquisition process, as an example, of a system through which a secured acquisition can be performed in accordance with a preferred embodiment of the present invention. The figure presents a flow chart of an example algorithm implementing the present invention.

Although the process of acquisition is being exemplified in the enclosed algorithm, it should be emphasized that other algorithms can be built in order to form software that will perform the secured acquisition. It should be noted that the example by no means limits the scope of the present invention.

The present invention provides a method in which a client can purchase goods by using a client credit card terminal unit such as cellular phone in order to secure his credit card details. The exposure of the credit card details is still one of the major factors that prevent clients from purchasing goods using a credit card. Such a secured transaction can open the path for new clients to use their credit card in a safer and more trusted acquisition method.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1-19. (canceled)

20. A payment system for managing a payment by a client to a supplier, the system comprising: a trusted transfer-server configured to receive transaction data and to communicate said transaction data to a clearing credit card company, said transaction data comprising:
(i) supplier-identification data and client acquisition data received from the supplier; and
(ii) payment data received from the client;
wherein said payment data is submitted to the trusted transfer-server directly by the client.

21. The system of claim 20 wherein said trusted transfer-server is further configured to validate said payment data.

22. The system of claim 20 wherein said payment data comprises credit card data.

23. The system of claim 20 wherein said client acquisition data comprises details selected from a group consisting of: identity of items, quantity of items, cost of items, terms of acquisition, name of client, address to which products are to be shipped, payment terms and identification of communication means to the client.

24. The system of claim 20 further comprising a credit card terminal configured to submit said payment data from said client to said trusted transfer-server.

25. The system of claim 24 wherein said credit card terminal is selected from a group consisting of: devices having chips configured to encrypt said payment data, devices integrated into a computer keyboard, credit card reading devices, telephones and combinations thereof.

26. The system of claim 20 wherein said trusted transfer-server comprises:
an acquisition-transfer server in communication with said client and said supplier, said acquisition-transfer server being configured to receive said transaction data, and
a secured-payment server configured to validate said transaction data.

27. The system of claim 20 wherein said trusted transfer-server comprises a clearing credit card system.

28. A credit card terminal configured to submit said payment data from said client to said trusted transfer-server of the system of claim 20.

29. A method for managing a payment by a client to a supplier, said method comprising:
step (b)—said supplier sending supplier-identification data and client-acquisition data to said trusted transfer-server;
step (c)—said transfer-server receiving said supplier-identification data and said client-acquisition data from said supplier;
step (f)—said client sending payment data directly to a trusted transfer-server;
step (g)—said transfer-server receiving said payment data from said client; and
step (h)—said transfer-server sending transaction data to a clearing credit card company, said transaction data comprising said payment data, said supplier-identification data and said client-acquisition data.

30. The method of claim 29 comprising a preliminary step:
step (a)—said client sending said client-acquisition data to said supplier.

31. The method of claim 29 further comprising the additional step:
step (d)—said transfer-server sending a payment data request to said client.

32. The method of claim 31 wherein said payment data request comprises a unique acquisition identification generated by said transfer-server.

33. The method of claim 29 further comprising the additional step:
step (e)—a credit card terminal encrypting said payment data.

34. The method of claim 29 wherein said transfer-server comprises an acquisition transfer server configured to receive said transaction, data wherein step (h) of said transfer-server sending transaction data to a clearing credit card company comprises said acquisition transfer server sending said transaction data to a secured payment server configured to validate said payment data.

35. The method of claim 29 further comprising the additional step:
step (i)—said transfer-server validating said payment data.

36. The method of claim 29 further comprising the additional step:
step (j)—said transfer-server sending an update message to at least one of said client and said supplier.

37. The method of claim 36 wherein said update message comprises at least one of a group consisting of: a success message upon completion of transaction, a notification of data being received, a notification of data being transferred to a clearing credit clearing company, a notification of data validation, an error message, a request for resubmission of data, commercial data and a presentation of an advertisement.
